(19) United States
(12) Patent Application Publication
(10) Pub. No.: US 2018/0105671 A1
(43) Pub. Date: Apr. 19, 2018

(54) Oriented polyester films with increased thermal conductivity

(71) Applicant: Mitsubishi Polyester Film GmbH, Weisbaden (DE)

(72) Inventors: Andreas BORK, Westhofen (DE); Holger KLEISCH, Ginsheim-Gustavsburg (DE); Bodo KUHMANN, Runkel (DE); Ingo FISCHER, Heistenbach (DE); Viktor FISCHER, Mainz (DE); Thiemo HERBST, Mainz (DE); Matthias WUCHTER, Reutlingen-Gonningen (DE); Christian HENNE, Nufringen (DE)

(21) Appl. No.: 15/727,705

(22) Filed: Oct. 9, 2017

(30) Foreign Application Priority Data
Oct. 17, 2016 (DE) 10 2016 220 280.4

(51) Int. Cl. C08K 3/36; C08K 5/134; C08L 67/02

(52) U.S. Cl. CPC C08K 3/36; C08L 67/02; C08K 5/134

(57) ABSTRACT

The present invention relates to an at least monoaxially oriented polyester film with increased thermal conductivity which incorporates particles based on silicates in order to increase the resulting thermal conductivity. A process for the production of these films is also described, as well as their use as electrical insulation material.

### CROSS-REFERENCE TO RELATED APPLICATIONS

This application claims priority to German Patent Application 10 2016 220 280.4 filed Oct. 17, 2016, which is hereby incorporated herein by reference in its entirety.

### FIELD OF THE INVENTION

At least monoaxially oriented polyester film with increased thermal conductivity which comprises particles based on silicates in order to increase thermal conductivity. A process for the production of these films is described, as also is their use as electrical insulation material.

The present invention relates to a polyester film with increased thermal conductivity ≥0.3 W m⁻¹ K⁻¹ which comprises at least from 10 to 45% by weight of a silicate particle. The film is at least monoaxially oriented and consists mainly of polyethylene terephthalate, but preferably comprises at least one comonomer. The film of the invention is suitable for use as electrical insulation material, for example as rear-side film for solar modules, as motor insulation film, or as insulation film in computers and electronic equipment of any type.

A process for the production of the polyester film is moreover described.

### BACKGROUND OF THE INVENTION

The film used in electrical insulation applications have to comply with a large number of requirements. Firstly, they must exhibit a high electrical insulating effect (dielectric strength, tracking resistance), whilst additionally letting through the heat resulting from the electrical current, in order to avoid overheating of the current-carrying components. These two properties are usually inversely correlated, and in particular therefore many traditional electrical insulation materials have rather low thermal conductivity. By way of example, the thermal conductivity of biaxially oriented polyethylene terephthalate films, which are often used because of their high dielectric strength, is less than or equal to 0.2 W m⁻¹ K⁻¹. The thermal conductivity of HOSTAPHAN® RN 190 perpendicularly to the plane of the film (TIMA measurement method) is by way of example 0.2 W m⁻¹ K⁻¹. The thermal conductivity of unmodified KAPTON® film (DuPont polyimide) is 0.12 W m⁻¹ K⁻¹ according to datasheet. The polyimides currently used as electrical insulation films in industry, e.g. KAPTON® MT with aluminium oxide as thermally conductive filler and thermal conductivity of 0.46 W m⁻¹ K⁻¹ according to datasheet are extremely expensive. Furthermore, there are no films obtainable with sufficiently high overall dielectric strength (thickness) for many applications, for example motor insulation film.

Polyester molding compositions with increased thermal conductivity have been produced by way of example by a method based on EP 2209845 with the use of glass beads or calcium fluoride particles; that patent specification contains no examples with polyester, and the size of the CaF particles described, 30 μm, makes them unsuitable for the production of oriented polyester films. Particles of this type of size lead, during orientation, to large voids (gas inclusions) in the film which would significantly reduce thermal conductivity, and lead to film break-offs, making industrial production of the film impossible. A logical consequence is that the specification also contains no examples relating to oriented films.

Particles with relatively high conductivity have been described in the literature. Particularly high conductivity is provided by way of example by the following: graphite >100 W m⁻¹K⁻¹, boron nitride >30 W m⁻¹K⁻¹, corundum >30 W m⁻¹ K⁻¹ and periclase >25 W m⁻¹ K⁻¹. However, particles having lower conductivity also have high thermal conductivity when compared with plastics, examples being: cyanite or cristobalite about 8-10 W m⁻¹ K⁻¹, MgO.Al₂O₃ 6.8 W m⁻¹ K⁻¹, quartz 3-7 W m⁻¹ K⁻¹, magnetite Fe₃O₄>4.5 W m⁻¹ K⁻¹, talc powder Mg₃[Si₄O₁₀][OH]₂>1.5 W m⁻¹ K⁻¹, SrFe₁₂O₁₉>3 W m⁻¹ K⁻¹ and rutile 3-5 W m⁻¹ K⁻¹.

The suitability of polyester film as electrical insulator is known from the literature, the dielectric strength of polyethylene terephthalate (PET) being significantly increased by at least monoaxial, preferably biaxial orientation.

Additional important criteria for electrical insulation applications, in particular at elevated temperatures, are that the polyester exhibits relatively high hydrolysis resistance and exhibits thermos-oxidative resistance.

### SUMMARY OF ADVANTAGEOUS EMBODIMENTS OF THE INVENTION

The object of the present invention consisted in producing a polyester film with increased thermal conductivity >0.3 W m⁻¹ K⁻¹K⁻¹ which can be produced on existing polyester film plants and is amenable to at least monoaxial orientation, and which moreover has a dielectric strength of at least 90 kV mm⁻¹ in accordance with DIN 40634 (at 23° C. and AC). The tensile strain at break of the film is moreover at least 5% in each film direction, and the relative temperature index (RTI) of the film is at least 90° C. The RTI value correlates with the temperature in ° C. in which the film fails during sustained use. The film can be produced in a thickness of from 9 to 400 μm. The film of the invention is to be suitable for use as electrical insulation material, e.g. as rear-side film for solar modules, as motor-insulation film, or as insulating film in computers and electronic equipment of any type.

### DETAILED DESCRIPTION OF ADVANTAGEOUS EMBODIMENTS OF THE INVENTION

Said object is achieved via an at least monoaxially oriented, single- or multilayer polyester film which has thermal conductivity ≥0.3 W m⁻¹ K⁻¹ perpendicularly to the plane of the film, where:
the film comprises at least from 10 to 45% by weight of a silicate particle,
the silicate particles have a d₅₀ value of from 0.1 to 15 μm,
the film consists at least 50% by weight of a polymeric component, and in turn at least 75 mol % of this component consists of a thermoplastic polyester.

Total film thickness is at least 9 μm and at most 400 μm. Film thickness is preferably at least 100 μm and at most 350 μm and ideally at least 120 μm and at most 300 μm. If film thickness is less than 9 μm, it cannot be produced in a reliable process with the silicate-particle-fill levels described above, and is moreover suitable only for low-voltage applications. Above 400 μm, production on existing polyester plants becomes uneconomic, and it becomes impossible to achieve sufficiently rapid cooling on a chill roll. If films thicker than 400 μm are required for high-voltage applications, two or more plies of the films of the invention must be adhesive-bonded (laminated) to one another by suitable processes.

The thermal conductivity of the film is at least 0.3 W m⁻¹ K⁻¹, preferably at least 0.35 W m⁻¹ K⁻¹ and ideally 0.45 W m⁻¹ K⁻¹. Below 0.3 W m⁻¹ K⁻¹, the advantage achieved through higher thermal conductivity is then generally not sufficient to compensate the economic disadvantage arising through the introduction of large amounts of particles. These quantities reduce not only the mechanical strength of the film but also its breakdown voltage, and increase production costs, not only because they themselves are expensive but also because the film plants become more susceptible to stoppages.

Fillers that come into consideration when the material is intended to be simultaneously thermally conductive and electrically insulating are ceramic fillers such as hexagonal boron nitride (hBN), aluminium oxide (Al₂O₃) or silicon carbide (SiC). High fill levels are required in order to achieve a significant increase in thermal conductivity: at least 10% by weight, more preferably 20% by weight.

When suitable particles are selected to improve thermal conductivity, consideration must always be given to the high dielectric strength that is also required by the object of the invention. For this reason it is not possible to use metal particles or to use carbon-based fillers such as graphite, carbon black, carbon fibres or carbon nanotubes (CNT). These are electrical current conductors, and with these fillers it is therefore not possible to achieve the required dielectric strength of 90 kV mm⁻¹, in accordance with DIN 40634 (at 23° C. and AC), together with good thermal conductivity. Although, therefore, it was possible to introduce quantities of up to 8% by weight of graphite into the film without any significant reduction of dielectric strength, no increase in thermal conductivity was achieved when these quantities were present.

Other fillers cannot be used because they have high toxicity, an example being BeO. Periclase and MgO spinels likewise proved to be unsuitable because they react with the polyesters of the invention and lead to substantial molecular-weight decrease (hydrolysis) in the polyester (therefore rendering production of the film impossible); the actual particle also undergoes significant loss of thermal conductivity due to conversion of the MgO component at the surface to Mg(OH)₂.

Boron nitride (BN), aluminium nitride, and also silicon carbide are unsuitable as sole thermal-conductivity particles because they do not bind satisfactorily into the polymer matrix. During stretching, this low compatibility leads to air-filled voids around the particles which act as additional insulator in the film; thermal conductivity thus either does not increase or increases only very slightly. Because hBN (hexagonal BN) has an inert structure, it is not possible to achieve a significant increase in the interactions at the surface, even with the aid of compatibilizers (for example aminosilanes). These compatibilizers are unable to generate a sufficient interaction with hBN, either via covalent bonding or via Van der Waals forces.

If pure aluminium oxide (corundum) is used in the quantities required to increase thermal conductivity (at least 10% by weight), it causes severe abrasion of the film-extrusion die, due to its high hardness (Mohs hardness about 9). After as little as a few minutes of extrusion, considerable quantities of metal particles (electrically conductive) were detectable in the film.

Rutile is similar to corundum in that its use produces increased abrasion at the film-extrusion dies, but this remains within a tolerable order of magnitude. However, rutile is similar to boron nitride in that when it is used voids form around portions of the particle, and it was not therefore possible to achieve increased thermal conductivity by using rutile.

In contrast, crystalline silicates such as quartz, cyanite and cristobalite have proven to be suitable (amorphous silicates and aluminosilicates do not lead to increased thermal conductivity).

Cristobalite is obtainable by way of example as filler from Quarzwerke GmbH with trademark SILBOND® cristobalite (e.g. 8000 RST). This filler has the same thermal conductivity in all directions and therefore has particularly good suitability for films. Hardness, about 6.5 Mohs hardness, is comparable with that of glass fibers. Because this filler has a cubic structure, its behavior in relation to wear is, however, significantly less aggressive than that of glass fibers.

In an embodiment which is preferred, alongside cristobalite, the thermally conductive particle consists of aluminium silicate, preferably Al₂O₃—SiO₂, particularly preferably in the form of cyanite. Cyanite has proven to be particularly suitable because it has high thermal conductivity in all axes and comparatively low hardness of from 4.5 to 7 Mohs hardness (dependent on the crystal direction), and especially because it provides good binding into the polyester matrix. Suitable cyanite particles are obtainable by way of example with trademark SILATHERM® from Quarzwerken GmbH (Frechen, Germany).

The particles of the invention can be used with or without surface-modifier. The following are preferably used as surface-modifier: methacrylsilanes, trimethylsilanes and methylsilanes, and particularly preferably epoxysilanes and aminosilanes. Modification of the surface can further improve binding into the polyester matrix, thus further reducing void-formation. Modification of the surface moreover also improves uniformity of distribution in the polyester matrix. This also has a favorable effect on mechanical properties such as tensile strength, modulus of elasticity, tensile strain at break, ultimate elongation and impact resistance.

It has been found that the d₅₀ of the particles is advantageously <15 μm, preferably <10 μm and particularly preferably <6 μm. The do here is preferably above 0.1 μm and particularly preferably above 0.5 μm. This firstly improves the reliability of running of the film plant with decreasing particle size and moreover leads to higher thermal conductivity. Surprisingly, thermal conductivity decreases again below a d₅₀ of 500 nm, and particularly below 100 nm.

For good extrusion and film processing, another requirement is that the d₉₈ of the particles is <40 μm, preferably <25 μm and particularly preferably <15 μm. If the d₉₈ is >40 μm, the largest particle fraction causes break-offs in the stretching process. During the extrusion process for the melting of the polymer, variations arise in melt viscosity and melt pressure. The melt film is therefore subject to width variations, and this leads to problems in the introduction of the film into the callipers of the combi-frame.

The proportion of the particles introduced to increase thermal conductivity is at least 10% by weight, preferably at least 12% by weight and ideally at least 13% by weight. A further increase leads to a further improvement in thermal conductivity, but also to significant impairment of tensile strain at break and of dielectric strength. The proportion of the particles used in the invention is therefore less than 45% by weight, preferably less than 40% by weight and ideally less than 37% by weight.

Surprisingly, although when boron nitride is used as sole thermally conductive particle it does not, for the reasons described above, lead to any significant increase in the thermal conductivity of the film, it is possible to achieve a further increase in thermal conductivity in combination with the crystalline particles of the invention. In an embodiment that is preferred, therefore, from 10 to 30% by weight, preferably from 12 to 25% by weight, of a silicate particle of the invention are combined with from 5 to 15% by weight, preferably from 6 to 10% by weight, of a hexagonal boron nitride particle. It has been found that the particle size (d₅₀) of the boron nitride is advantageously <15 μm, preferably <6 μm and ideally <3 μm. An example of a suitable particles is NX1® from Momentive Materials. Addition of the quantity mentioned of boron nitride usually achieves an increase of 0.1 W m⁻¹ K⁻¹ in conductivity in comparison with use of silicate particles alone. Use of boron nitride as additional particle leads to slight impairment of tensile strain at break and dielectric strength in comparison with addition of the same additional quantity of crystalline silicate particle. Addition of boron nitride has the disadvantage that these particles are more expensive than the silicate particles.

The film has either one layer or more than one layer, and a requirement here in the case of multilayer structures is maximal uniformity of distribution of the selected particles of the invention over the respective layers. In order to increase film stability (while simultaneously reducing thermal conductivity), the concentration of the silicate particles of the invention in the external layers can be reduced, while simultaneously increasing the quantity of the silicate particles in the internal layer(s) enclosed by the external layers, where at least 90% of the film thickness is provided by one or more internal layers. A requirement here is that the total content of thermally conductive filler is within the range of the invention: from 10 to 45% by weight (based on the composition of all of the layers).

In an embodiment that is preferred, the film has one layer, because homogeneous distribution of the thermally conductive filler can be realized particularly efficiently in single-layer embodiments.

In another embodiment that is preferred, the film has at least two layers, and at least one of these layers makes up less than 10% of the total thickness, this layer being an outer layer (external layer) and comprising less than 10% by weight of the silicate particles of the invention, and preferably less than 5% by weight of the silicate particles of the invention. Although it leads to slight impairment of the thermal conductivity of the film, it leads to a significant improvement in the tensile strain at break and dieletric strength of the film.

The film consists of at least 50% by weight of a polymeric component. At least 75 mol % of the polymeric component of the film and, respectively, of the base layer B and of any other layers of the film consists of a thermoplastic polyester. Materials that can be present alongside the thermoplastic polyester are other polymers, e.g. polyamides, polyimides, polyetherimides (e.g. ULTEM® from Sabic) or polycarbonates. However, these almost always, with the exception of polyetherimides, lead to significantly impaired reliability of running and a significantly impaired thermal conductivity, because of their poor miscibility with polyesters, or lead to significantly increased costs (in particular in the case of polyetherimides). It is therefore preferable that more than 85 mol % of the polymeric component consists of a thermoplastic polyester, and ideally more than 95 mol % of the polymeric component consists of a thermoplastic polyester.

It is preferable that the thermoplastic polyester consists of ethylene glycol and terephthalic acid (=polyethylene terephthalate, PET), of ethylene glycol and naphthalene-2,6-dicarboxylic acid (=polyethylene 2,6-naphthalate, PEN), or else of any desired mixture of the carboxylic acids and diols mentioned. Particular preference is given to polyesters consisting of at least 80 mol %, preferably at least 83 mol % and ideally at least 88 mol %, of ethylene glycol units and terephthalic acid units. Use of naphthalene-2,6-dicarboxylic acid has the advantage, in comparison with the use of terephthalic acid, of higher long-term heat resistance, but at significantly higher raw materials price, and use of naphthalene-2,6-dicarboxylic acid can therefore usually be avoided because of its higher price. The remaining monomer units are described as comonomers and derive from other aliphatic, cycloaliphatic or aromatic diols and, respectively, dicarboxylic acids. Examples of suitable other aliphatic diols are diethylene glycol, triethylene glycol, aliphatic diols of the general formula HO—(CH₂)ₙ—OH, where n is preferably less than 10, cyclohexanedimethanol, butanediol, propanediol, etc. Examples of suitable other dicarboxylic acids are isophthalic acid, adipic acid, etc. It has been found that, for long-term heat resistance, diethylene glycol advantageously provides less than 5 mol %, preferably less than 3 mol %, of the diol component of the thermoplastic polyester. For the same reasons, it has been found that isophthalic acid (IPA) advantageously provides less than 12 mol %, preferably less than 10 mol %, and ideally less than 6 mol %, of the dicarboxylic acid component of the thermoplastic polyester. It has moreover been found that CHDM (1,4-cyclohexanedimethanol) advantageously provides less than 2 mol %, ideally less than 1 mol %, of the diol component of the thermoplastic polyester. However, use of comonomers such as isophthalic acid and diethylene glycol improves stretchability and the binding of the particle into the material. In an embodiment that is preferred, the proportion of diethylene glycol is therefore at least 0.6 mol %, preferably at least 0.9 mol % and ideally at least 1.3 mol %, based on the diol component of the thermoplastic polyester. For the same reason, in an embodiment that is preferred isophthalic acid content, based on the dicarboxylic acid component, is at least 1 mol %, preferably at least 1.5 mol % and ideally at least 2 mol %.

In principle, it has been found that an increased quantity of the preferred comonomers isophthalic acid and diethylene glycol up to the maximal limits leads to an improvement in thermal conductivity, but with simultaneous impairment of RTI value and dielectric strength.

For reliability of running of the film, and in particular for achieving the RTI values of the invention, the SV value of the film is of great importance. The average SV value of the polyester raw materials used is therefore at least 600, preferably at least 700 and in particular at least 750. The average SV value of the raw materials used is less than 1000 and preferably less than 950, and in particular less than 920. If the value is above 1000, economic production on conventional polyester film plants generally becomes impossible, because the extruders exceed their maximal current levels at conventional throughput rates, and the throughput rates therefore have to be greatly reduced. Starting at an average SV of 920, SV degradation in the extruder increases greatly, because of high shear. As the proportion of degraded polymer in the film increases, achievable RTI decreases. Degradation (average SV of raw materials used minus SV value of the film) is therefore less than 150 SV units, preferably less than 100 SV units and in particular less than 50 SV units (and in this connection see also production process conditions).

Alongside the achievable SV of the films and a low degradation value, there are other measures that can have a favorable effect on RTI. In particular if use of antimony compounds as catalyst is avoided during production of the polyester, from 100 to 5000 ppm of a free-radical scavenger (a thermal oxidation stabilizer) are advantageously added to the film, the content here preferably being from 400 to 2000 ppm and in particular from 500 to 1200 ppm. Contents smaller than 50 ppm lead to no measurable improvement in thermal stability, and contents higher than 5000 ppm have no further improving effect on the thermal stability of the film and therefore merely reduce cost-effectiveness. Contents above 1200 ppm moreover tend to lead to the formation of gels with high stabilizer content and a yellow tinge.

Free-radical scavenger used can either preferably be a single compound, or less preferably can be a mixture of various free-radical scavengers.

The free-radical scavenger(s) used is/are preferably selected from the group of the phenolic antioxidants, or from the group of the antioxidants comprising at least the following structural element

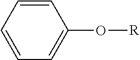

R=various organic moieties, see substance examples below.

The following compounds have low toxicity and good properties as free-radical scavengers, and are therefore preferred free-radical scavengers for the purpose of the invention: 5,7-Di-tert-butyl-3-(3,4- and 2,3-dimethylphenyl)-3H-benzofuran-2-one (comprising a) 5,7-di-tert-butyl-3-(3,4-dimethylphenyl)-3H-benzofuran-2-one (from 80 to 100% by weight) and b) 5,7-di-tert-butyl-3-(2,3-dimethylphenyl)-3H-benzofuran-2-one (from 0 to 20% by weight), CAS No. 88-24-4=2,2′-methylenebis(4-ethyl-6-tert-butylphenol), CAS No. 96-69-5=4,4′-thiobis(6-tert-butyl-3-methylphenol), CAS No. 119-47-1=2,2′-methylenebis(4-methyl-6-tertbutylphenol), CAS No. 128-37-0=2,6-di-tert-butyl-p-cresol, CAS No. 991-84-4=2,4-bis(octylmercapto)-6-(4-hydroxy-3,5-di-tert-butylanilino)-1,3,5-triazine, CAS No. 1709-70-2=1,3,5-trimethyl-2,4,6-tris(3,5-di-tert-butyl-4-hydroxybenzyl)benzene, CAS No. 1843-03-4=1,1,3-tris(2-methyl-4-hydroxy-5-tert-butylphenyl)butane, CAS No. 2082-79-6=octadecyl 3-(3,5-di-tert-butyl-4-hydroxyphenyl)propionate, CAS No. 3135-18-0=3,5-di-tert-butyl-4-hydroxybenzylphosphonic acid, dioctadecyl ester, CAS No. 4130-42-1=2,6-di-tert-butyl-4-ethylphenol, CAS No. 6683-19-8=pentaerythritol tetrakis[3-(3,5-di-tertbutyl-4-hydroxyphenyl)propionate), CAS No. 23128-74-7=1,6-hexamethylenebis(3-(3,5-di-tert-butyl-4-hydroxyphenyl)propionamide), CAS No. 25013-16-5=tert-butyl-4-hydroxyanisole, CAS No. 27676-62-6=1,3,5-tris(3,5-di-tert-butyl-4-hydroxybenzyl)-1,3,5-triazine-2,4,6(1H,3H,5H)trione, CAS No. 32509-66-3=ethylene glycol bis[3,3-bis(3-tert-butyl-4-hydroxyphenyl)butyrate], CAS No. 32687-78-8=N,N′-bis(3-(3,5-di-tert-butyl-4-hydroxyphenyl)propionyl)hydrazide, CAS No. 35074-77-2=1,6-hexamethylenebis(3-(3,5-di-tert-butyl-4-hydroxyphenyl)propionate), CAS No. 35958-30-6=1,1-bis(2-hydroxy-3,5-di-tert-butylphenyl)ethane. CAS No. 36443-68-2=triethylene glycol bis[3-(3-tert-butyl-4-hydroxy-5-methylphenyl)propionate], CAS No. 36443-68-2=triethylene glycol bis[3-(3-tert-butyl-4-hydroxy-5-methylphenyl)propionate], CAS No. 40601-76-1=thiodiethanol bis(3-(3,5-di-tert-butyl-4-hydroxyphenyl)propionate). CAS No. 57569-40-1=terephthalic acid, diesters with 2,2′-methylenebis(4-methyl-6-tert-butylphenol), CAS No. 61167-58-6=acrylic acid, 2-tert-butyl-6-(3-tert-butyl-2-hydroxy-5-methylbenzyl)-4-methylphenyl ester, CAS No. 65140-91-2=3,5-di-tert-butyl-4-hydroxybenzylphosphonic acid, monoethyl ester, calcium salt, CAS No. 70331-94-1=2,2′-oxamidobis[ethyl 3-(3,5-di-tert-butyl-4-hydroxyphenyl)propionate], CAS No. 110553-27-0=2,4-bis(octylthiomethyl)-6-methylphenol, CAS No. 110675-26-8=2,4-bis(dodecylthiomethyl)-6-methylphenol.

The molar mass of the free-radical scavengers having the structural element of the invention should be greater than 300 g/mol and particularly preferably greater than 500 g/mol and ideally greater than 700 g/mol, because compounds with lower molar masses have excessive volatility at the processing temperatures typical for polyesters and therefore are to some extent lost by evaporation during film production. This can lead to problems during production (vaporization, odor, formation of voids in the film, etc.), and moreover has the disadvantage of increasing tendency toward migration out of the film. This applies inter alia to the compounds mentioned in the above list with the CAS numbers: 2082-79-6, 25013-16-5, 128-37-0. Quantities used of compounds with molar mass below 300 g/mol are therefore preferably less than 500 ppm and particularly preferably less than 300 ppm and ideally zero. Quantities used of compounds with molar mass below 500 g/mol are therefore preferably less than 1000 ppm and particularly preferably less than 500 ppm and ideally zero.

When nitrogen-containing compounds from the above list were used, they led to films with higher yellowness indexes. This is undesirable; the quantity used of free-radical scavengers having nitrogen in their molecular formula is preferably less than 1000 ppm, particularly preferably less than 500 ppm and ideally zero.

Free-radical scavengers having sulfur in their molecular formula generated a characteristic odour, perceived to be somewhat unpleasant, during production of the film, and are therefore less preferred. Quantities used of free-radical scavengers having sulfur in their molecular formula are preferably less than 500 ppm, particularly preferably less than 300 ppm and ideally zero.

Compounds having particularly good properties in respect of thermal stability, in respect of little migration out of the film, and in respect of yellow coloration were those with the CAS No. 1709-70-2, 3135-18-0, 6683-19-8 and 57569-40-1. These are preferred free-radical scavengers for the purposes of the invention. Compounds to which particular preference is given here for the reasons mentioned are those with the CAS No. 1709-70-2 and 6683-19-8.

The free-radical scavenger(s) can be added to the polyester either directly during polymer production or else subsequently via incorporation of the compounds into a finished polyester. In the case of incorporation into a finished polyester, CAS No. 1709-70-2 (Irganox 1330) has proven to be particularly suitable, because with this compound no void-formation or vaporization was observed.

For achievement of an RTI of the invention, it has moreover proven advantageous that the thermoplastic polyester of the film has low carboxy end group content (CEG). In an embodiment that is preferred, this is less than 40 mmol/kg of film, and particularly preferably less than 30 mmol/kg and ideally less than 27 mmol/kg. Low carboxy end group contents can by way of example be achieved via use of polyester raw materials with carboxy end group contents of less than 20 mmol/kg of raw material and then by using non-aggressive extrusion conditions. The meaning of non-aggressive extrusion conditions here is low temperature as far as possible below 300° C. in the metering zones of the extruders used and high fill level of the extruder with low rotation rate (in the case of twin-screw extruders) and, respectively, good predrying (single-screw extruders) and devolatilization of the melt (twin-screw extruders). The low CEG value can also preferably be achieved by way of catalytic decarboxylation as described by way of example in EP2251371. Less preference is given to establishment of low CEG contents by means of addition of hydrolysis stabilizer as described by way of example in EP2184311.

For achievement of the RTI values of the invention and of the dielectric strengths of the invention it is very important that the film is at least monoaxially oriented. The higher the area stretching ratio (MD×TD stretching; machine direction=MD, transverse direction=TD), the higher the RTI value. Once the area stretching ratio has reached 16, no further increase in the RTI value is obtained. Below an area stretching ratio of 2, it is impossible to achieve either the RTI values of the invention or the dielectric strength of the invention. The higher the area stretching ratio, the lower the thermal conductivity of the film. The area stretching ratio is therefore at least 2 and preferably at least 3 and ideally at least 5. In an embodiment that is preferred, the area stretching ratio is below 16, particularly preferably below 14 and ideally below 13. If area stretching ratios above 9 are used, the proportion of comonomer in the film (total of DEG and IPA) is advantageously at least 1.6 mol %.

The ultimate elongation of the film in longitudinal direction and transverse direction is greater than 5%, particularly preferably greater than 15% and ideally greater than 20%. If ultimate elongation is below 5%, the film can easily break during further processing, e.g. during folding in motor film (motor insulation film), and could therefore no longer be used for most applications. The higher the particle content, the lower the ultimate elongation. Above 45% by weight particle content, the ultimate elongation values of the invention become unachievable.

Modulus of elasticity in at least one film direction is at least 1000 N mm⁻², preferably at least 1500 N mm⁻² and particularly preferably at least 2000 N mm⁻². It is particularly preferable that these values are achieved in both film directions. If modulus of elasticity is smaller than 1000 N mm⁻², there is a risk of undesirably excessive elongation of the film during further processing, with a resultant significant reduction of dielectric strength.

The dielectric strength of the polyester film of the invention is at least 90 kV mm⁻¹, preferably at least 100 kV mm⁻¹ and ideally 110 kV mm⁻¹. The dielectric strength of the invention is achieved by establishing the area stretching ratios in the range of the invention; dielectric strength increases here until the area stretching ratio reaches 5, but decreases again above 12. Dielectric strength is moreover established in the range of the invention via specific selection of the comonomers (ratio of amount of substance). In particular, dielectric strength decreases significantly above the comonomer contents of the invention. If contents of thermally conductive particles used are above the ranges of the invention, it is impossible to achieve the dielectric strength of the invention.

The relative temperature index (RTI value) of the polyester film of the invention is at least 90. The RTI value correlates with the temperature in ° C. at which the film fails in long-term use. The RTI value of the film is at least 90, preferably at least 95 and ideally 105. The RTI value is similar to dielectric strength in that it increases with increasing stretching ratio and decreases with increasing proportion of comonomer. Within the ranges of the invention for these values, the RTI values of the invention are achieved.

The RTI value is moreover favorably influenced by the use of thermal oxidation stabilizers and the use of hydrolysis-resistant raw materials or stabilizers.

The film of the invention has excellent suitability for use in rear-side laminates of solar modules, and the thickness of the film in this case is at least 100 μm. Use of the film results in dissipation of more heat from the cells, and therefore reduced temperature of these, and increased efficiency of the module. One of the principal uses of the film of the invention is the use as motor film for the electrical insulation of electric motors. The thickness of the film in this application is at least 96 μm and preferably more than 150 μm. It is thus possible to dissipate the heat from the motor more rapidly; resistance in the motor coil is thus reduced, and the motor consumes less current. Overheating of the motor is moreover avoided. The film is also used inter alia as sheet-insulation material in small electrical devices such as laptops and mobile phones, thickness here generally being below 50 μm. Other applications are found in air-conditioning systems, heating systems of all types, and lamps such as LED lamps.

Other factors of decisive importance for heat dissipation, alongside the thermal conductivity of the film, are the surface and the contact with the adjacent medium. Contact between film and adjacent surface should as far as possible be free from gaps and from air inclusions. It has been found to be advantageous to establish the contact by use of a resin, an adhesive, a paste, a hotmelt adhesive film or the like. The contact medium here is by way of example melted in order to fill uneven regions and regions of micro roughness. Here again, addition of thermally conductive particles of the type described above proves to be helpful, so that the contact medium does not in turn function as thermal insulator. This layer does not function as electrical insulator, and, unlike the polyester film, does not have to be oriented during the production process, and there are therefore fewer resultant restrictions in the selection of the particles. Equally, if the contact medium is of appropriate chemical type, there is then no need to consider restrictions relating to degradation reactions involving the polyester.

In one form of the invention, a contact medium described is provided to the modified polyester film in order to improve contact with, and thus heat dissipation to, the adjacent layer. In the case of rear-side laminates by way of example this layer is the encapsulation material, for example made of EVA or silicone, and in the case of motor insulation systems it is another insulation material to improve thermal classification.

### Production Process

The polyester polymers of the individual layers are produced by polycondensation, either starting from dicarboxylic acids and diol or else starting from the esters of the dicarboxylic acids, preferably the dimethyl esters, and diol. SV values of polyesters that can be used are in the range from 500 to 1300; the individual values here are not very important, but the average SV value of the raw materials used must be greater than 600 and is preferably below 1000.

The thermally conductive pigments, and also any other additives that may be present, can be added during production of the polyester. For this, the particles are dispersed in the diol, optionally ground, decanted and added to the reactor either in the (trans)esterification step or in the polycondensation step. A concentrated particle-containing or additive-containing polyester masterbatch can preferably be produced by using a twin-screw extruder, and can be diluted with particle-free polyester during film extrusion. It has been found here that use of masterbatches comprising less than 30 mol % of polyester is advantageously avoided. In particular, the masterbatch comprising silicate particles should comprise no more than 50 mol % of silicate (because of the risk of gel formation). Another possibility consists in adding particles and additives directly during the film extrusion in a twin-screw extruder.

If single-screw extruders are used, it has proven to be advantageous to predry the polyesters. If a twin-screw extruder with vent zone is used, the drying step can be omitted.

The polyester, or the polyester mixture, of the layer or, of the individual layers in the case of multilayer films, is first compressed and rendered flowable in extruders. The melt(s) is/are then shaped in a single-layer die or coextrusion die to give flat melt films, and forced through a slot die, and drawn off on a chill roll and one or more take-off rolls, with cooling and solidification.

In order to facilitate achievement of the RTI values of the invention, the temperature of the melt at the respective extruder outlets should not be above 305° C., and preferably not above 300° C. These temperatures are achieved via cooling of the metering zones of the extruder and/or by establishing a low extruder rotation rate together with a high fill level of the extruder (for twin-screw extruders).

The film of the invention is at least monoaxially oriented, i.e. at least monoaxially stretched. In the case of biaxial orientation of the film, orientation is most often carried out sequentially. It is preferable here to begin by orientating in longitudinal direction (i.e. in machine direction, =MD) and then to orientate in transverse direction (i.e. perpendicularly to machine direction, =TD). Orientation in longitudinal direction can be carried out with the aid of two rolls running at different speeds corresponding to the desired stretching ratio. An appropriate tenter frame is generally used for the transverse orientation.

The temperature at which stretching is carried out can vary within a relatively wide range, and depends on the desired properties of the film. The stretching in longitudinal direction is generally carried out in a temperature range from 80 to 130° C. (heating temperatures from 80 to 130° C.) and the stretching in transverse direction is generally carried out in a temperature range from 90° C. (start of stretching) to 140° C. (end of stretching). In order to achieve the desired film properties, the stretching temperature (in MD and TD) is advantageously below 125° C. and preferably below 118° C. Before transverse stretching, one or both surfaces of the film can be coated in-line by the processes known per se. The in-line coating process can by way of example be used to apply an adhesion-promoter system or to apply a coating. During the heat-setting that follows, the film is kept under tension at a temperature of from 150 to 250° C. for a period of about 0.1 to 10 s and, in order to achieve the desired shrinkage values and elongation values, relaxed in transverse direction by at least 1%, preferably at least 3% and particularly preferably at least 4%, insofar as transverse orientation has been carried out. This relaxation preferably takes place in a temperature range from 150 to 190° C. The film is then wound up in conventional manner.

### Other Film Properties

It is preferable that, after the process described above, the shrinkage at 150° C. of the film of the invention in longitudinal and transverse direction is below 6%, preferably below 2% and particularly preferably below 1.5%. The expansion of this film at 100° C. is moreover less than 3%, preferably less than 1% and particularly preferably less than 0.3%. This dimensional stability can be obtained by way of example through simple relaxation of the film before wind-up (see process description). This dimensional stability is important in order that, during use in motors, the strips do not suffer any subsequent shrinkage which could lead to a lack of electrical insulation in the outer regions of the motor.

### Analysis

The following measured values were used to characterize the raw materials and the films:

### Measurement of Median Particle Diameter d₅₀

A Malvem MASTERSIZER® 2000 is used to determine the median diameter d₅₀ of the particle to be used.

For this, the samples are charged with water to a cell, and these are then placed to into the measurement equipment. A laser is used to analyse the dispersion, and the particle size distribution is determined from the signal by comparison with a calibration curve. The particle size distribution is characterized by two parameters, the median value d₅₀ (=measure of position of the central value) and the degree of scattering, the value known as SPAN98 (=measure of scattering of the particle diameter). The measurement procedure is automatic, and also includes mathematical determination of the d₅₀ value. The d₅₀ value here is defined as being determined from the (relative) cumulative particle size distribution curve: the point of intersection of the 50% ordinate value with the cumulative curve provides the desired d₅₀ value on the abscissa axis. The definition of the de value is analogously based on the point of intersection of the 98% ordinate value.

### SV Value (Standard Viscosity)

Standard viscosity in dilute solution (SV) was measured by a method based on DIN 53728 part 3 at (25±0.05) ° C. in an Ubbelohde viscometer. Dichloroacetic acid (DCA) was used as solvent. The concentration of the dissolved polymer was 1 g of polymer per 100 ml of pure solvent. Dissolution of the polymer was continued for 1 hour at 60° C. If the samples were not completely dissolved after this time, up to two further dissolution attempts, each lasting 40 minutes, were carried out at 80° C., and the solutions were then centrifuged for 1 hour at a rotation rate of 4100 min⁻¹.

The dimensionless SV value is determined as follows from the relative viscosity (ηᵣₑₗ=η/ηₛ):

SV=(ηᵣₑₗ−1)×1000

The proportion of particles in the film or polymer was determined by ashing, and a correction was applied by using an appropriately increased input weight, i.e.:

Input weight=(Input weight corresponding to 100% of polymer)/[(100 particle content in % by weight)/100)]

### Mechanical Properties

Mechanical properties were determined by way of a tensile test by a method based on DIN EN ISO 572-1 and -3 (specimen type 2) on film strips measuring 100 mm×15 mm.

### Shrinkage

Thermal shrinkage was determined on square film samples with edge length 10 cm. The samples were cut out in a manner that gave one edge running parallel to machine direction and one edge running perpendicular to the machine direction. The samples were measured accurately (edge length L₀ being determined for each direction TD and MD: L_{0 TD} and L_{0 MD}), and were conditioned in a convection drying oven at the stated shrinkage temperature (in this case 150° C.). The samples were removed and measured accurately at room temperature (edge length L_{TD} and L_{MD}). The shrinkage is obtained from the following equation:

Shrinkage [%]MD=100·(L_{0 MD}−L_{MD})/L_{0 MD}, and

Shrinkage [%]TD=100·(L_{0 TD}−L_{TD})/L_{0 TD}

### Expansion

Thermal expansion was determined on square film samples with edge length 10 cm. The samples were measured accurately (edge length L₀), conditioned for 15 minutes at 100° C. in a convection drying oven, and then measured accurately at room temperature (edge length L). Expansion is obtained from the following equation:

Expansion [%]=100·(L−L₀)/L₀

and was determined separately in each film direction.

### Thermal Conductivity

The thermal conductivity of films is determined by using the “Thermal Interface Material” method on the TIMA equipment from Berliner Nanotest and Design GmbH described in WO2012107355 (A1). A paste is first spread onto the film surface on both sides, in order to eliminate surface effects such as roughness and to provide maximal contact between sample and measurement equipment. The paste has known thermal conductivity. A suitable material for this purpose is by way of example “DOW CORNING® 340 Heat Sink Compound” silicone thermal conductivity paste. The sample thus prepared is clamped at room temperature between two reference bodies made of CuZn—CuZn, using a constant pressure of 600 kPa. The contact area is 132.7 mm². One reference body has in turn been connected to a heat source controlled to 100° C. The other reference body is located on a heat dissipater with temperature 15° C. The temperature profile across the two reference bodies is measured. From this it is possible to calculate the thermal interfacial resistance of the system R_{th,total}, and from this the thermal interfacial resistance of the sample R_{th,film} is obtained. For a known thickness and contact area, this can be used to calculate the thermal conductivity λ perpendicularly to the sample plane.

R_{th,film}=R_{th,total}−2*R_{th,paste}

Rₜₕ: Thermal interfacial resistance

$${R}_{th , paste} = 0.079 K \text{/} W$$

$$λ = \frac{Thickness of sample}{{R}_{th , film} \cdot Area}$$

### RTI

For determination of temperature-time limits, the samples are aged for different times at at least three temperatures in a convection oven. A property value (ultimate elongation, based on initial value before treatment in the convection oven) is measured after equilibration to room temperature before and after the heat-aging. The respective temperature-dependent time required for this property value to reach a defined limiting value (≤2%) is determined.

Ultimate elongation is determined as described above by a method based on DIN EN ISO 572-1 and 572-3 (specimen type 2) on film strips measuring 100 mm×15 mm.

These experiments are evaluated by plotting the property value against the heat-aging time. The aging times at which the samples fail at the respective temperature are plotted on a semilogarithmic scale against reciprocal aging temperature (in K⁻¹). The resultant straight line is extrapolated to 20 000 hours. The temperature corresponding to a lifetime of 20 000 hours is read from the graph here and termed temperature index TI.

### Measurement of Breakdown Voltage/Dielectric Strength

Breakdown voltage is measured in accordance with DIN 53481-3 (with reference to DIN 40634 for specific instructions for films). Measurements are made using a ball-and-plate system (electrode diameter 49.5 mm) with 50 Hz sinusoidal alternating voltage in air at 23° C. and rel. humidity 50.

Dielectric strength is measured in accordance with IEC 60674 using 20 mm ball, 50 mm plate and 50 Hz AC, and averaged over 10 measurement points.

### EXAMPLES

The polymer mixtures are melted at 292° C. and, via a slot die, applied electrostatically to a chill roll controlled to 50° C. The film is then stretched longitudinally and then transversely under the following conditions:

| | | | |
|---|---|---|---|
| Longitudinal | Heating temperature | 75-115 | ° C. |
| stretching | | | |
| | Stretching temperature | 115 | ° C. |
| | Longitudinal stretching ratio | Varies | |
| | | between 1 | |
| | | and 4 | |
| Transverse | Heating temperature | 100 | ° C. |
| stretching | | | |
| | Stretching temperature | 112 | ° C. |
| | Transverse stretching ratio | Varies | |
| | (inclusive of stretching in | between 1 | |
| | 1^{st} setting field) | and 4 | |
| Setting | Temperature | 237-150 | ° C. |
| temperature | | | |
| | Duration | 3 | s |
| | Relaxation in TD at 200-150° C. | 5 | % |
| Setting | Temperature of 1^{st} setting field | 170 | ° C. |

The following raw materials are used in the examples (in the invention):

PET1=polyethylene terephthalate made of ethylene glycol and terephthalic acid with SV value 1100 and DEG content 0.9 mol % (diethylene glycol content based on diol component).
PET2=polyethylene terephthalate made of ethylene glycol and terephthalic acid with SV value 840.
PET3=polyethylene terephthalate with SV value 830, 22.4 mol % of isophthalic acid (based on dicarboxylic acid component).
PEN=polyethylene naphthalate with SV value 580.
PET4=polyethylene terephthalate with SV value 580 and 50% by weight of AB 253753 AlN aluminium nitride with d₅₀ 55 μm (H. C. Starck, Munich. Germany). The particle was incorporated into the polyethylene terephthalate PET1 in a twin-screw extruder.
PET5=polyethylene terephthalate with SV value 550 and 50% by weight of GRADE B BN hexagonal boron nitride with d₅₀ 10 μm (H. C. Starck, Munich, Germany). The particle was incorporated into the polyethylene terephthalate PET1 in a twin-screw extruder.
PET6=polyethylene terephthalate with SV value 580 and 50% by weight of SILBOND® 8000 RST cristobalite silicon dioxide particles with d₅₀ 2 μm (Quarzwerke GmbH, Frechen, Germany). The SiO₂ was incorporated into the polyethylene terephthalate PET1 in a twin-screw extruder.
PET7=polyethylene terephthalate made of ethylene glycol and terephthalic acid with SV value 870 and 10 mmol/kg carboxy end group content.
PET8=PET1 with 5000 ppm of IRGANOX® 1330, CAS No. 1709-70-2 (produced by BASF Schweiz) incorporated by means of a twin-screw extruder. SV value 780.

| | | Comparative | Inventive | Inventive | Inventive | Inventive | Comparative |
|---|---|---|---|---|---|---|---|
| | | example 1 | example 1 | example 2 | example 3 | example 4 | example 2 |
| PET1 | [%] | 30 | 47.5 | 36.5 | 10 | 47.5 | |
| PET2 | [%] | 70 | | | | | |
| PET3 | [%] | | 25 | 25 | 25 | | 5 |
| PEN | [%] | | | | | 25 | |
| PET4 | [%] | | | | | | |
| PET5 | [%] | | | | | | |
| PET6 | [%] | | 27.5 | 38.5 | 37 | 27.5 | 95 |
| PET7 | [%] | | | | 20 | | |
| PET8 | [%] | | | | 8 | | |
| SV mixture | | 918 | 895 | 840 | 776 | 833 | 692 |
| Area stretching ratio | | 13.69 | 6.66 | 5.58 | 7 | 9 | 12.25 |
| Thickness | [μM] | 75 | 105 | 110 | 145 | 125 | 75 |
| Thermal conductivity | [W/(m · | 0.20 | 0.40 | 0.38 | 0.46 | 0.35 | 0.56 |
| λ perpendicular to | K)] | | | | | | |
| film plane | | | | | | | |
| Modulus of elasticity | [N/mm²] | 4000 | 2500 | 2500 | 2600 | 3200 | 2000 |
| in MD | | | | | | | |
| Breaking force in MD | [N/mm²] | 191 | 53 | 49 | 57 | 118 | 30 |
| Tensile strain at | [%] | 145 | 8 | 10 | 38 | 60 | 1.9 |
| break in MD | | | | | | | |
| Dielectric strength | [kV/mm] | 205 | 205 | 205 | 185 | 190 | 195 |
| RTI | [C.] | 130 | 100 | 100 | 130 | 135 | 72 |
| Comment | | | | | | | Poor |
| | | | | | | | reliability |
| | | | | | | | of running, |
| | | | | | | | break-offs |

| | | Comparative | Comparative | Comparative | Comparative | Inventive |
|---|---|---|---|---|---|---|
| | | example 3 | example 4 | example 5 | example 6 | example 5 |
| PET1 | [%] | 50 | 50 | 50 | 50 | 41.5 |
| PET2 | [%] | 30 | 30 | 30 | 30 | |
| PET3 | [%] | | | | | 25 |
| PEN | [%] | | | | | |
| PET4 | [%] | 20 | 20 | | | |
| PET5 | [%] | | | 20 | 20 | 13.5 |
| PET6 | [%] | | | | | 20 |
| PET7 | [%] | | | | | |
| PET8 | [%] | | | | | |
| SV mixture | | 918 | 918 | 912 | 912 | 888 |
| Area stretching ratio | | 12.25 | 1 | 1 | 9 | 12.25 |
| Thickness | [μM] | 115 | 450 | 275 | 85 | 70 |
| Thermal conductivity | [W/(m · | 0.23 | 0.34 | 0.35 | 0.20 | 0.35 |
| λ perpendicular to | K)] | | | | | |
| film plane | | | | | | |
| Modulus of elasticity | [N/mm²] | 2800 | 1200 | 1400 | 2200 | 2500 |
| in MD | | | | | | |
| Breaking force in MD | [N/mm²] | 77 | | | | 50 |
| Tensile strain at | [%] | 32 | 300 | 380 | 70 | 45 |
| break in MD | | | | | | |
| Dielectric strength | [kV/mm] | 205 | 60 | 60 | 205 | 205 |
| RTI | [C.] | 130 | 75 | 75 | 130 | 105 |
| Comment | | Metallic | Metallic | | | |
| | | material | material | | | |
| | | abraded | abraded | | | |
| | | from | from | | | |
| | | extruder | extruder | | | |

That which is claimed:

1. Single- or multilayer, at least monoaxially oriented polyester film comprising from 10 to 45% by weight of crystalline silicate particles, based on the total weight of the film, wherein
the d₅₀ value of the crystalline silicate particles is from 0.1 to 15 μm,
the crystalline silicate particles are cyanite and/or cristobalite
and where the film comprises a polymeric constituent that makes up at least 50% by weight of the film and at least 75 mol % of said polymeric constituent consists of a thermoplastic polyester.

2. Film according to claim 1, wherein more than 85 mol % of the polymeric constituent of the film consists of the thermoplastic polyester and the thermoplastic polyester consists of at least 80 mol % of ethylene glycol units and terephthalic acid units.

3. Film according to claim 1, wherein the silicate particles have been coated with methacrylic silane, trimethylsilane, methylsilane, epoxysilane, aminosilane or a combination thereof.

4. Film according to claim 3, wherein the silicate particles have been coated with epoxysilane, aminosilane and combinations thereof.

5. Film according to claim 1, wherein the cyanite has a triclinic crystal structure and critstobalite has a tetragonal or cubic crystal structure.

6. Film according to claim 5, wherein the critstobalite has a cubic crystal structure.

7. Film according to claim 1, wherein the de value of the crystalline silicate particles is less than 40 μm.

8. Film according to claim 7, wherein the d₉₈ value of the crystalline silicate particles is less than 25 μm.

9. Film according to claim 1, wherein said film comprises from 10 to 30% by weight of crystalline silicate particles and from 5 to 15% by weight of hexagonal boron nitride.

10. Film according to claim 9, wherein said film comprises from 5 to 25% by weight of crystalline silicate particles and from 6 to 10% by weight of hexagonal boron nitride.

11. Film according to claim 9, wherein the d₅₀ value of the hexagonal boron nitride is less than 15 μm.

12. Film according to claim 11, wherein the ds value of the hexagonal boron nitride is less than 6 μm.

13. Film according to claim 1, wherein the film is a multilayer film and at least one of these layers makes up less than 10% by weight of the total thickness of the film, and said layer is an outer layer and comprises less than 10% by weight of the crystalline silicate particles, based on the total weight of the film.

14. Film according to claim 13, wherein said layer comprises less than 5% by weight of the crystalline silicate particles, based on the total weight of the film.

15. Film according to claim 1, wherein the film comprises at least one free-radical scavenger and the free-radical scavenger content is in the range from 100 to 5000 ppm, based on the mass of the film.

16. Film according to claim 15, wherein the free-radical scavenger content is in the range from 400 to 2000 ppm based on the mass of the film.

17. Film according to claim 15, wherein the free-radical scavenger is a phenolic antioxidant and comprises the structural element (I) 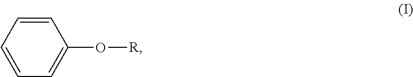
where R is an organic moiety, and
the molar mass of the free-radical scavenger is greater than 300 g/mol.

18. Film according to claim 15, wherein the molar mass of the free-radical scavenger is greater than 500 g/mol.

19. Film according to claim 1, wherein the film has
a thickness of from 9 to 400 μm,
a thermal conductivity of at least 0.3 W m⁻¹ K⁻¹,
an area stretching ratio in the range from 2 to 16,
a tensile strain at break of more than 5%,
a modulus of elasticity of at least 1000 N mm⁻²,
a dielectric strength of at least 90 kV mm⁻¹, and
a relative temperature index (RTI value) of at least 90.

20. Process for producing a film according to claim 1 comprising
compressing and rendering flowable via extruders the polyester or polyester mixture of the film, or of the individual layers of the film in the case of multilayer films,
shaping the resultant flowable melt(s) in a single-layer die or coextrusion die and forcing the shaped melt through a slot die to give flat melt film(s),
drawing off the flat melt film(s) on a chill roll and one or more take-off rolls,
cooling and solidifying the film from the take-off roll(s),
at least monoaxially stretching the cooled and solidified film,
heat-setting the stretched film, and
winding up the heat-set film, wherein
the film comprises from 10 to 45% by weight of crystalline silicate particles, based on the total weight of the film,
the d₅₀ value of the crystalline silicate particles is from 0.1 to 15 μm,
the crystalline silicate particles are cyanite and/or cristobalite
and the polymeric constituent of the film makes up at least 50% by weight of said film and at least 75 mol % of said polymeric constituent consists of a thermoplastic polyester.

21. Electrical insulation material comprising a single- or multilayer at least monoaxially oriented polyester film as claimed in claim 1, wherein
the film comprises from 10 to 45% by weight of crystalline silicate particles, based on the total weight of the film,
the d₅₀ value of the crystalline silicate particles is from 0.1 to 15 μm,
and the polymeric constituent of the film makes up at least 50% by weight of the film and at least 75 mol % of polymeric said constituent consists of a thermoplastic polyester.

22. Solar modules, electric motors, computers or other electronic equipment comprising film as claimed in claim 1.
